(19) United States
(12) Patent Application Publication
(10) Pub. No.: US 2019/0200190 A1
(43) Pub. Date: Jun. 27, 2019

(54) CHAT BETWEEN DRIVERS USING DATA FROM LICENSE PLATES

(71) Applicant: Continental Automotive Systems, Inc., Auburn Hills, MI (US)

(72) Inventor: Antonio Rios Cortes, Tlajomulco de Zuniga (MX)

(21) Appl. No.: 16/226,922

(22) Filed: Dec. 20, 2018

Related U.S. Application Data
(60) Provisional application No. 62/610,906, filed on Dec. 27, 2017.

(51) Int. Cl. H04W 4/46; G06K 9/32; H04W 4/12

(52) U.S. Cl. CPC H04W 4/46; H04W 84/18; H04W 4/12; G06K 9/325

(57) ABSTRACT

A method of communicating from a first vehicle to a second vehicle, the method including: recognizing from the first vehicle a license plate of the second vehicle; generating a messaging address of the second vehicle based on the recognized license plate of the second vehicle; and transmitting from the first vehicle a message to the messaging address of the second vehicle. Recognizing the license plate may include recognizing a state of the license plate and a license-plate number of the license plate. The generated messaging address of the second vehicle may include both the state of the license plate and the license-plate number.

### BACKGROUND

Sometimes a driver of a vehicle sees a problem associated with another vehicle, such as, an underinflated tire, a door that has not been fully closed, a child with no seat belt, and the like. In situations of this type, the vehicle driver typically would like to notify people in the other vehicle. But, most of the time, communication of this type is not feasible. Techniques for facilitating this type of communication would be an improvement.

### BRIEF SUMMARY

Embodiments of the invention are directed to a method of communicating from a first vehicle to a second vehicle, the method including: recognizing from the first vehicle a license plate of the second vehicle; generating a messaging address of the second vehicle based on the recognized license plate of the second vehicle; and transmitting from the first vehicle a message to the messaging address of the second vehicle. Recognizing the license plate may include recognizing a state of the license plate and a license-plate number of the license plate. The generated messaging address of the second vehicle may include both the state of the license plate and the license-plate number.

### BRIEF DESCRIPTION OF THE DRAWINGS

FIG. 1 depicts an example text that may be communicated from a sending vehicle to a receiving vehicle in accordance with embodiments of the invention.

FIG. 2 depicts another example text that may be communicated from a sending vehicle to a receiving vehicle in accordance with embodiments of the invention.

FIG. 3 depicts an example display of recently recognized license plates.

FIG. 4 depicts an example license plate.

FIG. 5 depicts an example messaging address generated in accordance with embodiments of the invention based on the license plate of FIG. 4.

### DETAILED DESCRIPTION

Embodiments of the invention are directed to sending messages to vehicles and receiving messages from other vehicles, smart phones, notebook computers, and the like, typically in the form of short text, voice, multimedia messages, and the like.

The state, numbers, and/or letters of a vehicle's license plate are recognized. Stated differently both the state and the license-plate number of a vehicle's license plate are recognized.

Automatic number-plate recognition (ANPR) is a technology that uses optical character recognition on images to read vehicle registration plates. It can use existing closed-circuit television, road-rule enforcement cameras, or cameras specifically designed for the task. ANPR is used by police forces around the world for law enforcement purposes, including to check if a vehicle is registered or licensed. It is also used for electronic toll collection on pay-per-use roads and as a method of cataloguing the movements of traffic, for example by highways agencies. ANPR may also be referred to as: Automatic (or automated) license-plate recognition (ALPR); Automatic, (or automated) license-plate reader (ALPR); Automatic vehicle identification (AVI); Car-plate recognition (CPR); License-plate recognition (LPR); Lecture automatique de plaques d'immatriculation (LAPI); Mobile license-plate reader (MLPR); Vehicle license-plate recognition (VLPR); Vehicle recognition identification (VRI).

A list of license plates recognized via ANPR may then be displayed to a vehicle occupant along with a user interface option for selecting a recognized license plate from the list of recognized plates in the event that a user wants to send a message to a vehicle with one of the recognized plates.

A messaging address may then be generated based on the recognized plate selected by the user through the user interface. For example, such a messaging address could take the form: state of plate+licence-plate-number+@carchat. As will be apparent to those skilled in the art, other suitable syntaxes for messaging addresses could also be used. A message is then sent to this messaging address with the content of the message that one vehicle occupant would like to send to an occupant of another vehicle.

Because the messaging addresses are based on recognized license plates, duplicate messaging addresses should be avoided.

In addition to license-plate recognition of other vehicles, other vehicles may also be recognized by other signals, including, but not limited to, IR, radio, Bluetooth, and the like.

An identifier for each car, such as the Vehicle Identification Number, could be assigned by vehicle manufacturers such that vehicles could announce their identifier and/or a messaging address associated with such an identifier, and then the vehicle's driver and/or occupants would be able to receive messages using a standard messaging address of the type described above.

Messages between vehicles may be sent and received by V2V communications, via the Internet, and/or other sources of communication like from Bluetooth, radio, etc.

Messages may be written or recorded by voice or camera. While driving, voice recognition would be preferred to minimize distracted driving. But a passenger could write or type a message and/or use a smartphone to take a picture or record video without the driver being distracted.

Older cars may participate in messaging between vehicles in accordance with embodiments of the invention by using a Smartphone to send and receive messages linked to data of vehicles from which and to which a message is to be sent.

In accordance with embodiments of the invention, communications may occur directly between vehicles, or between a smart phone in a first vehicle and a second vehicle, for example, via a smart phone ad hoc network (SPAN), which is a type of network that evolves from the underlying concept, architecture, and technology underlying a wireless ad hoc network. Once a smart phone or a cell phone embedded in a vehicle is enabled with ad hoc networking technology, the smart phone or vehicle-embedded cell phone can create ad hoc networks among other such devices. Smart phone ad hoc networks leverage the existing hardware (e.g., DSRC, Bluetooth, and the like) in commercially available smartphones and/or vehicle-embedded wireless transceivers to create peer-to-peer networks without relying on cellular carrier networks, wireless access points, or traditional network infrastructure. SPANs may use the mechanism behind Wi-Fi ad-hoc mode, which allows phones to talk directly among each other, through a transparent neighbor and route discovery mechanism.

SPANs differ from traditional hub and spoke networks, such as Wi-Fi Direct, in that they support multi-hop routing (ad hoc routing) and relays and there is no notion of a group leader, so peers can join and leave at will without destroying the network.

An owner and/or operator of a vehicle may have an option to not receive messages when they don't want to receive messages by turning off message notifications and/or simply not enabling them in the first place.

In accordance with embodiments of the invention, a brief description of the a vehicle may displayed in addition to the recognized license-plate, e.g. plate xx is a red silver Ford Mustang, and the like.

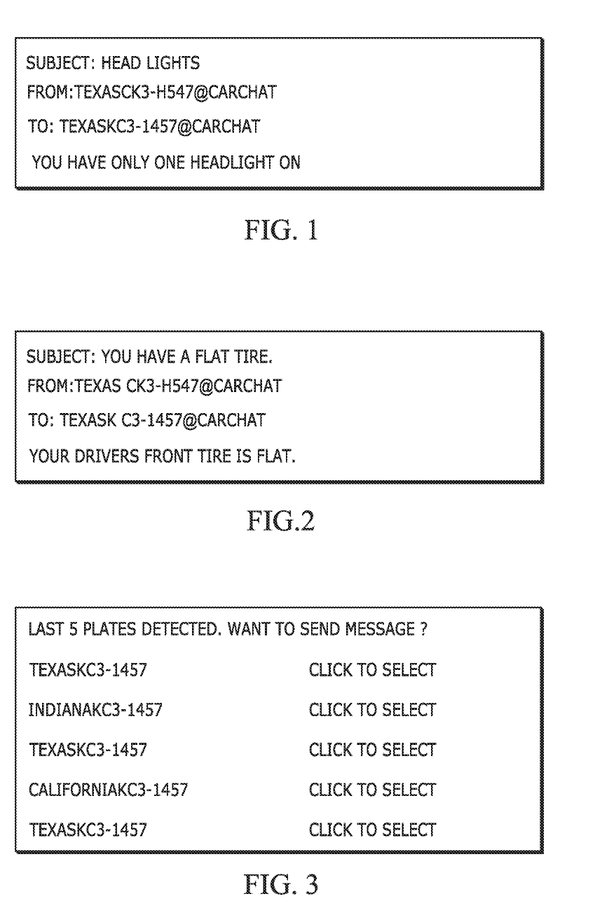

FIG. 1 depicts an example text that may be communicated from a sending vehicle to a receiving vehicle in accordance with embodiments of the invention.

FIG. 2 depicts another example text that may be communicated from a sending vehicle to a receiving vehicle in accordance with embodiments of the invention.

FIG. 3 depicts an example display of recently recognized license plates. As shown in FIG. 3 the state of the license plate and the license-plate number are both recognized and displayed. Selection links, labelled with “Click to select” in FIG. 3, are also provided to enable an occupant in the sending vehicle to select a receiving vehicle based on corresponding recognized license plates. As will be apparent to those skilled in the art, speech recognition, or any other suitable input means may also be used for selecting receiving vehicle through a user interface in the sending vehicle.

FIG. 4 depicts an example license plate. Texas is the state of the example license plate, and BC5X489 is the license-plate number of the example license plate.

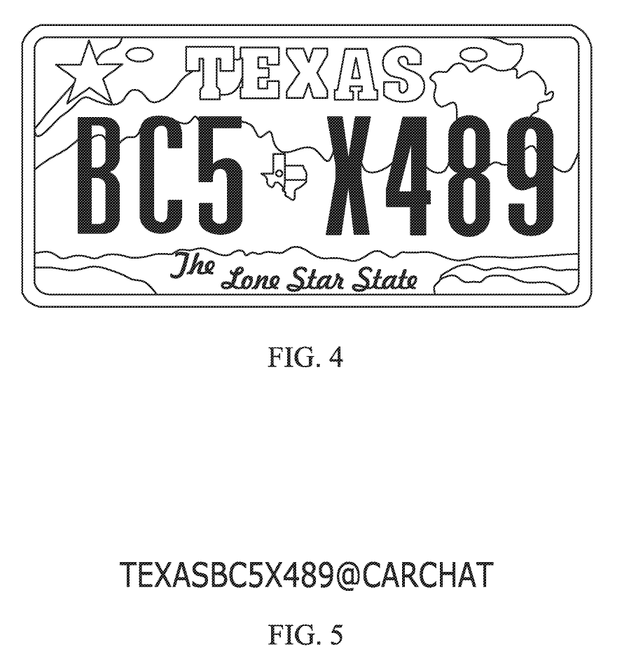

FIG. 5 depicts an example messaging address generated in accordance with embodiments of the invention based on the license plate of FIG. 4. As shown in FIG. 5, TEXASBC5X489@carchat is the example messaging address generated based on the license plate of FIG. 4.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

1. A method of communicating from a first vehicle to a second vehicle, the method comprising:
recognizing from the first vehicle a license plate of the second vehicle;
generating a messaging address of the second vehicle based on the recognized license plate of the second vehicle; and
transmitting from the first vehicle a message to the messaging address of the second vehicle.

2. The method of claim 1, wherein recognizing the license plate further comprises recognizing a state of the license plate and a license-plate number of the license plate.

3. The method of claim 2, wherein the generated messaging address of the second vehicle includes both the state of the license plate and the license-plate number of the license plate.

4. The method of claim 1, further comprising recognizing from the first vehicle a plurality of license plates from a plurality of vehicles and displaying a list of recognized license plates in the first vehicle.

5. The method of claim 1, wherein the second vehicle broadcasts a unique identifier associated with the second vehicle by at least one of IR, radio, Bluetooth, and DSRC.

6. The method of claim 1, wherein the second vehicle can disable receipt of messages from other cars.

7. The method of claim 1, wherein the message is transmitted to the messaging address of the second vehicle by at least one of the first vehicle, a smart phone in the first vehicle, and a personal computer in the first vehicle.

8. The method of claim 1, wherein the message contains at least one of: text, recorded voice, a picture, and a video recording.

9. The method of claim 1, wherein the message is transmitted directly from the first vehicle to the second vehicle.

10. The method of claim 9, wherein the message is transmitted directly from the first vehicle to the second vehicle via a wireless ad-hoc network.
